(19) United States
(12) Patent Application Publication
(10) Pub. No.: US 2012/0272098 A1
(43) Pub. Date: Oct. 25, 2012

(54) COMPUTER WITH POWER-OFF SYSTEM

(75) Inventor: WEI-DONG CONG, Shenzhen City (CN)

(73) Assignees: HON HAI PRECISION INDUSTRY CO., LTD., Tu-Cheng (TW); HONG FU JIN PRECISION INDUSTRY(ShenZhen) Co., LTD., Shenzhen City (CN)

(21) Appl. No.: 13/111,986

(22) Filed: May 20, 2011

(30) Foreign Application Priority Data
Apr. 20, 2011 (CN) 201110099334.5

(51) Int. Cl. G06F 11/07

(52) U.S. Cl. 714/24; 714/E11.023

(57) ABSTRACT

A computer includes a central processing unit (CPU), a power supply, a control unit, a switch unit connected to the CPU and the control unit, a north bridge chip connected between the switch unit and the power supply. The CPU includes a temperature detection unit to detect temperature of the CPU. When the temperature of the CPU is greater than a predetermined value, the CPU outputs a first low level signal to the switch unit. When the button is pressed, the control unit outputs a second low level signal to the switch unit. When the switch unit receives at least one of the first and second low level signals, the switch unit outputs a control signal to the north bridge chip to disable the power supply, thereby turning off the computer.

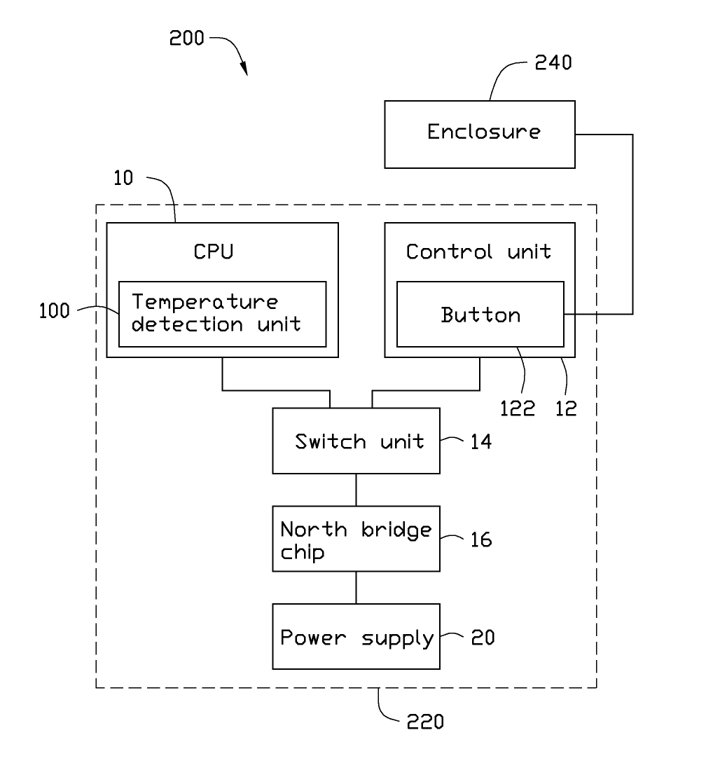

### BACKGROUND

1. Technical Field

The present disclosure relates to computers, and particularly, to a computer with a power-off system.

2. Description of Related Art

Computers can be turned off by a hard-power off or a soft-power off. A hard-power off is performed by pressing a physical power button of the computer and a soft-power off is performed by activating a software program. However, both hard and soft-power off takes about one minute to turn off the computer. If a computer needs to be turned off immediately for some urgent reason, a user could unplug the power cord from the alternating current (AC) power outlet, which is inconvenient.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present embodiments. Moreover, in the drawing, all the views are schematic, and like reference numerals designate corresponding parts throughout the several views.

The drawing is a block diagram of an embodiment of a computer power-off system.

### DETAILED DESCRIPTION

The disclosure, including the accompanying drawing in which like references indicate similar elements, is illustrated by way of example and not by way of limitation. It should be noted that references to “an” or “one” embodiment in this disclosure are not necessarily to the same embodiment, and such references mean at least one.

Referring to the drawing, an embodiment of a computer 200 includes a power-off system 220 and an enclosure 240. The power-off system 220 includes a central processing unit (CPU) 10, a control unit 12, a switch unit 14, a north bridge chip 16, and a power supply 20. The switch unit 14 is connected to the CPU 10, the control unit 12, and the north bridge chip 16. The north bridge chip 16 is also connected to the power supply 20 to enable or disable the power supply 20. In the embodiment, the switch unit 14 is an AND gate circuit. When either the control unit 12 or the CPU 10 outputs a low level signal to the switch unit 14, the switch unit 14 outputs a low level signal to the north bridge chip 16. The north bridge chip 16 disables the power supply 20 at once. The computer 200 is turned off. When the control unit 12 and the CPU 10 both output high level signals to the switch unit 14, the switch unit 14 outputs a high level signal to the north bridge chip 16. The north bridge chip 16 keeps the power supply 20 enabled to keep powering the computer 200.

The CPU 10 includes a temperature detection unit 100 to detect temperature of the CPU 10. The control unit 12 includes a button 122 mounted on the enclosure 240.

In a normal working state, the temperature of the CPU 10 is in a predetermined temperature range. The CPU 10 outputs a first high level signal to the switch unit 14. The control unit 12 outputs a second high level signal to the switch unit 14. The switch unit 14 receives the high level signals from the CPU 10 and the control unit 12, and outputs a third high level signal to the north bridge chip 16. The north bridge chip 16 keeps the power supply 20 enabled to keep powering the computer 200.

In an abnormal working state, for example, the temperature of the CPU 10 is higher than a predetermined value, the CPU 10 outputs a first low level signal to the switch unit 14. Or the button 122 is pressed, and the control unit 12 outputs a second low level signal to the switch unit 14. The switch unit 14 outputs a third low level signal to the north bridge chip 16. The north bridge chip 16 disables the power supply 20. The computer 200 is turned off immediately.

When an emergency occurs, such as hard disk drive (not shown) crashes, the button 122 can be pressed to turn off the computer 200 immediately.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A computer comprising:
a power-off system comprising:
a central processing unit (CPU) comprising a temperature detection unit to detect a temperature of the CPU;
a power supply to power the computer;
a control unit comprising a button;
a switch unit connected to the CPU to receive a first signal, and connected to the control unit to receive a second signal, thereby outputting a control signal according to the first and second signals; and
a north bridge chip connected between the switch unit and the power supply to receive the control signal, and enable or disable the power supply according to the control signal;
wherein when the temperature of the CPU is greater than a predetermined value, the first signal from the CPU is a first low level signal, when the button is pressed, the second signal from the control unit is a second low level signal, the switch unit receives at least one of the first and second low level signals, the switch unit outputs the control signal to the north bridge chip to disable the power supply, thereby turning off the computer.

2. The computer of claim 1, further comprising an enclosure, wherein the button is mounted on the enclosure.

3. The computer of claim 1, wherein the switch unit is an AND gate circuit.
